(19) United States
(12) Patent Application Publication
(10) Pub. No.: US 2019/0355199 A1
(43) Pub. Date: Nov. 21, 2019

(54) METHOD FOR RETRIEVING INFORMATION FROM A SECURITY DOCUMENT BY MEANS OF A CAPACITIVE TOUCHSCREEN

(71) Applicant: ORELL FÜSSLI SICHERHEITSDRUCK AG, Zürich (CH)

(72) Inventors: Sylvain CHOSSON, Zürich (CH); Martin EICHENBERGER, Zollikon (CH)

(73) Assignee: ORELL FÜSSLI SICHERHEITSDRUCK AG, Zürich (CH)

(21) Appl. No.: 16/473,669

(22) PCT Filed: Dec. 28, 2016
(86) PCT No.: PCT/CH2016/000160

§ 371 Date: Jun. 26, 2019

(51) Int. Cl. G07D 7/026; G06F 3/044; G06F 3/0354; G06K 7/14

(52) U.S. Cl. CPC G07D 7/026; G06K 7/1413; G06F 3/03545; G06F 3/044

(57) ABSTRACT

A security document includes a non-homogeneous region formed e.g. by a structure of bars that vary the document's thickness dielectric permittivity or electrical conductance. The structure is verified by placing the document on the capacitive touchscreen of a verification device. Then, the user moves a finger or pen along the structure, which gives rise to a varying capacitive signal in the verification device. The signal can then be analyzed for deriving information about the document.

### TECHNICAL FIELD

The invention relates to a method for retrieving information from a security document. Such a method can e.g. be used for testing the authenticity of the security document or for reading a value recorded therein.

### BACKGROUND ART

Various methods and devices for supporting the retrieval of information from a security documents have been known, such as those using optical scanners or magnetic scanners.

The ongoing fight against new methods of counterfeiting provides a constant need for new methods and devices that support the verification of security documents.

Also, it may be desired to read data from such documents, e.g. a denomination, a serial number, etc.

### DISCLOSURE OF THE INVENTION

Hence, the problem to be solved is to provide a method and device of the type mentioned above that can be used for retrieving information from a security document.

This problem is solved by the method according to the independent claim. Accordingly the method for retrieving information from a security document comprising the following steps:
Placing a security document on the capacitive touchscreen of a verification device: In this context, a “capacitive touchscreen” is a display device that contains a capacitive sensor array for measuring finger gestures thereon in spatially resolved manner.
Moving a finger or a pen along a non-homogeneous region of said security document while said region abuts against the touchscreen, thereby generating a varying capacitive signal in said touchscreen: Depending on the local thickness and composition of the security document, the capacitive signal will vary. In this context, the term “capacitive signal” designates a signal recorded by the capacitive touchscreen. A “non-homogeneous region” is a region where the document has non-homogeneous dielectric and/or conductive properties, in the sense that these properties vary along at least one direction parallel to the document's surface.
Retrieving, by means of said touchscreen, a dataset descriptive of said capacitive signal as a function of position. In other words, the dataset is such that it describes the capacitive signal as a function of the position of the finger or pen.
Analyzing said dataset in order to retrieve said information: Since the dataset has been recorded by moving the finger along the document while the document is on the touchscreen, the dataset will depend on the varying dielectric and/or conductive properties of the non-homogeneous region of the document, which makes it possible to retrieve information that depends on the document and e.g. allows a verification of the document or the reading out of information stored in the document.

In a first aspect of the invention, a finger is used for moving along the security document on the touchscreen in order to generate a capacitive signal. This allows to generate the dataset without any further tools.

In a second aspect of the invention, a pen is used for moving along the security document on the touchscreen in order to generate a capacitive signal. This has the potential advantage of increased accuracy and signal resolution as compared to the first aspect of the invention.

In this context, a “pen” is a tipped tool whose tip can be detected by the touchscreen, i.e. which generates a capacitive signal therein.

In the non-homogeneous region, the properties of the document must vary such that the capacitive signal as detected by the touchscreen varies with the location of the finger or pen.

Advantageously, at least one of the following parameters of the document should be non-homogeneous, i.e. non-constant along at least one direction parallel to the document's surface:
The thickness. In particular, the thickness of the document should vary in the non-homogeneous region by at least 10%, in particular by at least 30%.
The relative permittivity (also called the “dielectric constant”). In particular, the relative permittivity of the document should vary in the non-homogeneous region by at least 10%, in particular by at least 30%.
The electrical conductance. In particular, the electrical conductance of the document should vary in the non-homogeneous region by at least 10%, in particular by at least 30%.

In a specific example, the security document can comprise a metal structure. This metal structure can be detected as it strongly affects the relative permittivity as well as the conductance of the document.

The metal structure can e.g. be a metal foil laminated to or a metal-containing ink printed on the document.

For example, the optically variable device can form a diffraction grating.

In another advantageous embodiment, the security document is, in the non-homogeneous region, free of any metal structure, i.e. it does not contain a metal structure that could be detected by the touchscreen. This aspect of the invention is based on the understanding that purely dielectric inhomogeneities are enough to allow detection by means of a touchscreen.

In yet another embodiment, the document comprises a window arranged in its non-homogeneous region. In this context, a “window” is a sub-region of the document that is translucent or transparent.

The invention is particularly suited for security documents that are banknotes or identification documents.

### BRIEF DESCRIPTION OF THE DRAWINGS

The invention will be better understood and objects other than those set forth above will become apparent when consideration is given to the following detailed description thereof. This description makes reference to the annexed drawings, wherein:

FIG. 1 shows a banknote with a non-homogeneous region for being scanned on a touchscreen,

FIG. 2 shows the process of scanning the banknote of FIG. 1,

FIG. 3 is a view of the scanning process with the capacitive signal,

FIG. 4 shows the capacitive signal in respect to the structure in the non-homogeneous region,

FIG. 5 shows a second embodiment of a security document encoding two different pieces of information,

FIG. 6 shows a third embodiment of a security document where part of the structure in the homogeneous region is formed by a laminated patch.

### MODES FOR CARRYING OUT THE INVENTION

### Basic Principles and First Embodiment

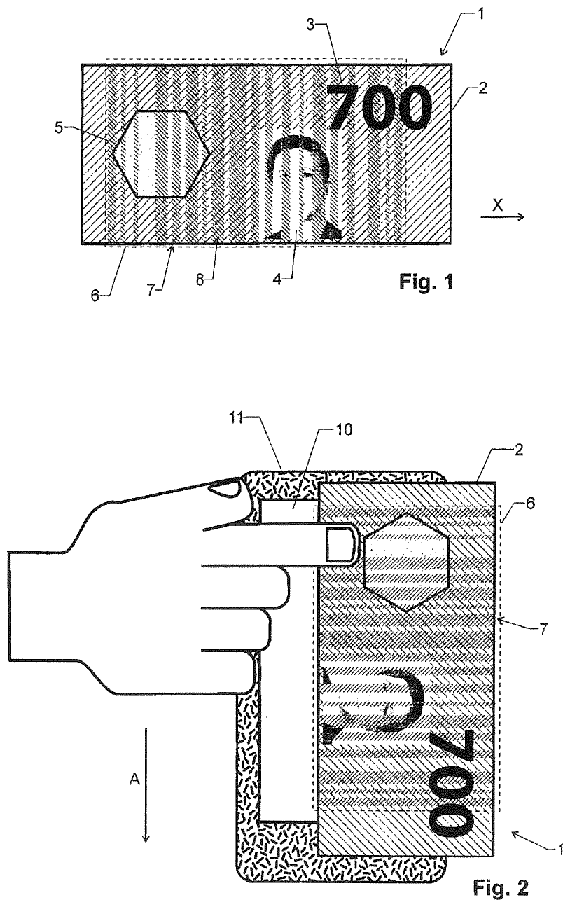

FIG. 1 shows a banknote 1 as an example for a security document. It has a substrate 2 that is e.g. of paper, plastics or a combination thereof. The document typically carries printed insignia 3, 4, such as a denomination value and graphical or photographical motifs. It can also comprise other security features, such as a window 5, optically variable devices (such as diffractive structures), watermarks, security threads, etc.

Further, document 1 has a “non-homogeneous region” 6, which is enclosed in dashed lines in FIG. 1. Non-homogeneous region 6 contains a structure 7 that can be detected by placing the document against a capacitive touchscreen device and moving a finger or pen along it. In the embodiment shown here, structure 7 is formed by a plurality of bars 8

Various embodiments of non-homogeneous region 6 and structure 7 will be described in the next section.

FIG. 2 shows document 1 placed against a touchscreen 10 of a verification device 11. Verification device 11 can e.g. be a multipurpose smartphone or tablet PC loaded with suitable software for carrying out the present method, or it may be a dedicated device built for implementing the present method.

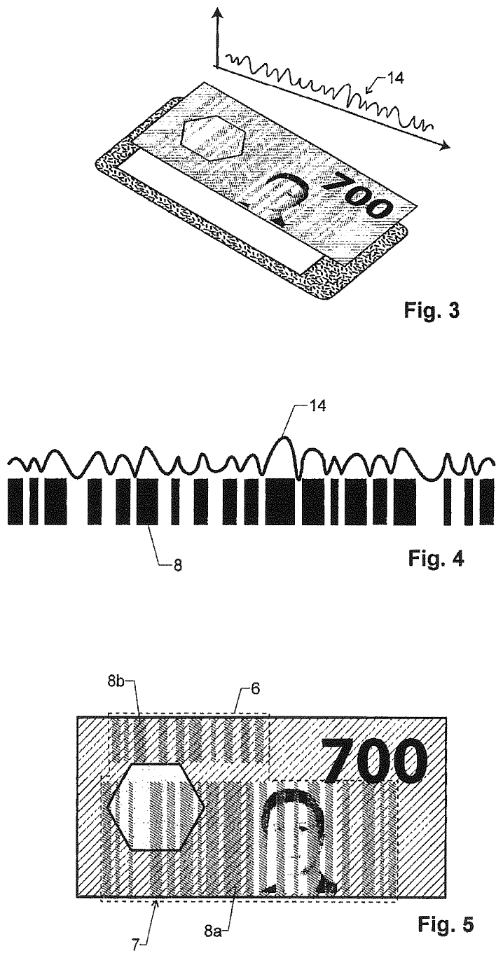

Once that document 1 is placed against device 11, in a position where non-homogeneous region 6 is in contact with touchscreen 10, the user moves his finger or a pen along structure 7, e.g. in a direction A as shown in FIG. 2, thereby generating a capacitive signal that varies as a function of the finger or pen position. This is illustrated in FIG. 3, where a curve 14 representing the signal as a function of position is shown, and in FIG. 4, where the signal 14 is shown as in relation to the bars 8 of structure 7.

In device 11, touchscreen 10 is used to retrieve a dataset descriptive of this capacitive signal as a function of position, e.g. as a table of position vs. measured capacitance value.

Then, the software in device 11 analyses this dataset, e.g. by searching for a given pattern and/or by N searching for information embedded therein. For example, if structure 7 forms a barcode or some other kind of encoded information, this analysis can comprise the step for decoding that information. This information can then e.g. be displayed on touchscreen 10, or device 11 can emit an acoustic signal, such as a voice signal, that describes the information, i.e. the information can be replayed by device 11 in optical or acoustic manner.

For example, if document 1 is a banknote, the denomination of the banknote can be encoded in non-homogeneous region 6, and verification device 11 can be structured and adapted to display and/or speak that denomination value. In this case verification device 11 can e.g. be used by visually impaired persons to check a banknote.

### Non-Homogeneous Region

As mentioned, non-homogeneous region 6 carries a structure 7 that can be detected by placing the document against a capacitive touchscreen 10 and moving a finger or pen along it.

In the embodiment of FIG. 1, the structure 7 comprises, as mentioned, bars 8. These bars advantageously extend perpendicularly to a longitudinal direction X of the document such that it can be scanned easily by moving the finger or pen along said longitudinal direction X.

Structure 7 is such that it generates an inhomogeneity in the dielectric or conductive properties of non-homogeneous region 6 that is sufficiently strong to be detected by means of a capacitive touchscreen.

This inhomogeneity corresponds to a variation of the dielectric or conductive properties along at least one direction, in particular longitudinal direction X, parallel to the document's surface.

There are various measures how this can be n implemented. Some examples are described in the following. These examples can be used individually or in any combination.

1) Structure 7 can give rise to a variation of thickness in the non-homogeneous region 6. Advantageously, the thickness should vary by at least 10%, in particular by at least 30%. When moving a finger or pen along this structure, the finger's distance from the touchscreen will vary, thereby causing a variation in the capacity measured by touchscreen 10.

This can e.g. be implemented by laminating structures to substrate 2, such as additional stripes of material, e.g. by using one or more transfer foils. Or it can be implemented by removing parts of substrate 2, thereby thinning it out. Or it can be implemented by embossing substrate 2, compressing it locally to reduce its thickness.

2) Structure 7 can give rise to a variation of (the real value of) the relative permittivity in the non-homogeneous region 6. Again, the permittivity should advantageously vary by at least 10%, in particular by at least 30%. When moving a finger or pen along this structure, the finger's capacitance towards the touchscreen will vary, thereby causing a variation in the capacity measured by touchscreen 10.

This can e.g. again be implemented by laminating structures to substrate 2, namely structures having a different permittivity from substrate 2. For example, PVC or silicone can have relative permittivities of 3 or more, much higher than those of most polymers and plastics, which are typically below 2.

3) Structure 7 can e.g. give rise to a variation of the conductance (i.e. the imaginary value of the complex permittivity) in the non-homogeneous region 6. Again, the conductance should advantageously vary by at least 10%, in particular by at least 30%. When moving a finger or pen along this structure, the finger's capacitance towards the touchscreen will vary, thereby causing a variation in the capacity measured by touchscreen 10.

This can e.g. again be implemented by laminating structures to substrate 2, namely structures having a different conductance from substrate 2. Particularly suited are metal structures. These metal structures may, in addition, carry a diffractive grating or another optically variable device, such as it will be described in respect to the third embodiment.

The metal structures can e.g. comprise a metal foil, which can, for example, be laminated to or embedded in substrate 2 using transfer foil techniques.

The metal structures can e.g. also comprise metal-containing ink printed on the document 1.

It must be noted, though, that structure 7 can also be free of any metal structure when the techniques of examples 1) or 2) as described above are used.

The structures 7 can, in any of the above examples 1), 2) and 3), be applied using various techniques, such as:
The structures 7 can, as mentioned, be formed by printing. The printing can take place on a surface of substrate 2 or, if substrate 2 is a multi-layer substrate, the printing can be applied between one or more layers of the substrate. Conventional printing techniques can be used, such as intaglio printing or screen printing (both of which allow to deposit large amounts of material and are therefore advantageous) or offset printing. Inkjet printing can be used, too, and it is particularly advantageous for applying personalized information, such as e.g. mentioned in reference to the second embodiment below.
The structures 7 can, as mentioned, be formed by laminated layers, such as e.g. described in the third embodiment below. These layers can again be applied on a surface of substrate 2 or embedded within substrate 2.

The structures 7 can be visible or invisible. For example, they can be rendered invisible (for the human eye) by embedding them within substrate 2 or by using an ink that is invisible to a human observer, such as a varnish (in the present context, the term ink is to be understood to include varnish).

In order to be detectable easily, the structure 7 that gives rise to the inhomogeneities in non-homogeneous region 6 advantageously has, at least along one n direction parallel to the document's surface, namely in the direction of scanning, i.e. direction X in the example of FIG. 1, a plurality of substantially homogeneous, but differing sections (such as the bars 8), where each of said sections has a width (along this direction X) of at least 1 mm, in particular of at least 5 mm.

### Second Embodiment

A second embodiment of a security document is shown in FIG. 5. It has basically the same design as the one of FIG. 1, but structure 7 comprises two sets of bars 8a, 8b encoding different types of information. For example, a first set of bars 8a can encode a banknote's denomination, while a second set of bars 8b can encode a serial number, or a partial serial number (e.g. only part of the serial number or a hash-code derived from the serial number), or it may encode a personalization—for example, if the document is a voucher, the second set of bars 8b can e.g. encode an owner or issuer of the voucher.

If at least part of the code is personalized or at least varies often, the corresponding part of structure 7 is advantageously applied to the document by means of inkjet printing.

### Third Embodiment

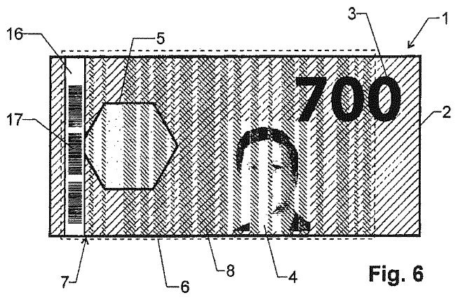

In the embodiment of FIG. 6, at least part of structure 7, i.e. at least part of the document's inhomogeneity that is exploited in the present method, is formed by a patch 16 laminated to substrate 2, e.g. using transfer technology.

Advantageously, and as shown, patch 16 comprises an optically variable device 17, such as a diffractive grating. However, optically variable device 17 may also comprise non-diffractive structures, such as a Fresnel structure, or a thin film giving rise to interference colors.

In the embodiment shown, patch 16 forms only part of structure 7, while the other parts thereof have been formed by the other techniques described above. However, alternatively, all of structure 7 can be formed by one or more patches 16.

Notes:

In the embodiments above, the security document is a banknote. It must be noted, though, that it can also be any other security document, in particular an identification document, such as a passport, or an ID card. It can also e.g. be a voucher or coupon or another document representing monetary value, or a certificate of authenticity.

In the embodiments shown above, document 1 comprises a window 5. This window is typically of a material different from the rest of substrate 2. It also can have a thickness that differs from the one of rest of substrate 2, in particular if substrate 2 is a multilayer substrate with one or more of the layers missing in the region of window 5. For example, substrate 2 can comprise a polymer layer as well as one or more paper layers (where the term paper includes cotton-based paper), with at least one of the paper layer(s) omitted at the location of window 5.

Hence, window 5 is also a suitable candidate for forming at least part of structure 7. In other words, at least part of the inhomogeneity of non-homogeneous region 6 can be formed by a window 5 of document 1.

Device 11 can be designed to assist the user in the process described here, e.g. by displaying or voicing instructions how to carry out the scanning of region 6.

In more general terms, the present technique can provide a security document having a non-homogeneous region 6 formed e.g. by a structure 7, such as bars 8, that varies the document's thickness, dielectric permittivity or electrical conductance. The structure 7 is verified by placing document 1 on the capacitive touchscreen 10 of a verification device 11. Then, the user moves a finger or pen along the structure 7, which gives rise to a varying capacitive signal in the verification device 11. The signal can then be analyzed for deriving information about the document.

While there are shown and described presently preferred embodiments of the invention, it is to be distinctly understood that the invention is not limited thereto but may be otherwise variously embodied and practiced within the scope of the following claims.

1. A method for retrieving information from a security document comprising the steps of
placing a security document on a capacitive touchscreen of a verification device,
moving a finger or a pen along a non-homogeneous region said security document while said region abuts against the touchscreen, thereby generating a varying capacitive signal in said touchscreen,
retrieving, by means of said touchscreen, a dataset descriptive of said capacitive signal as a function of position,
analyzing said dataset in order to retrieve said information.

2. The method of claim 1, comprising the step of moving a finger along said security document on said touchscreen thereby generating the capacitive signal in said touchscreen.

3. The method claim 1, comprising the step of moving a pen along said security document on said touchscreen thereby generating the capacitive signal in said touchscreen.

4. The method of claim 1, wherein, in said non-homogeneous region, a thickness of said document varies by at least 10%.

5. The method of claim 1, wherein, in said non-homogeneous region, a relative permittivity of said document varies by at least 10%.

6. The method of claim 1, wherein, in said non-homogeneous region, a conductance of said document varies by at least 10%.

7. The method of claim 1, wherein, in said non-homogeneous region, said security document comprises a metal structure.

8. The method of claim 7 wherein said metal structure comprises a metal foil.

9. The method of claim 7, wherein said metal structure comprises a metal-containing ink printed on the document.

10. The method of claim 1, wherein, in said non-homogeneous region, said security document is free of any metal structure.

11. The method of claim 1, wherein at least part of an inhomogencity of said non-homogeneous region is formed by a patch laminated to a substrate of said security document.

12. The method of claim 1, wherein at least part of an inhomogencity of said non-homogeneous region is formed by a window of said document.

13. The method of claim 1, wherein, in said non-homogeneous region, said security document comprises a structure formed by bars extending perpendicularly to a longitudinal direction (X) of the document.

14. The method of claim 1, wherein said document comprises a structure that gives rise to an inhomogeneity in said non-homogeneous region, wherein said structure has, at least in one direction, a plurality of substantially homogeneous, but differing sections having a width of at least 1 mm.

15. The method of claim 1, wherein said document is a banknote or an identification document.

16. The method of claim 1, wherein said non-homogeneous region encodes an information, and wherein said method comprises the steps of
decoding said information, and
replaying, by said verification device, said information in optical or acoustic manner.

17. The method of claim 16, wherein said document is a banknote and said information is a denomination of said banknote.

18. A method for retrieving information from a security document comprising the steps of
placing a security document on a capacitive touchscreen of a verification device,
moving a finger or a pen along a non-homogeneous region said security document while said region abuts against the touchscreen, thereby generating a varying capacitive signal in said touchscreen, wherein, in said non-homogeneous region, a thickness of said document varies by at least 10%, and wherein, in said non-homogeneous region, said security document is free of any metal structure,
retrieving, by means of said touchscreen, a dataset descriptive of said capacitive signal as a function of position,
analyzing said dataset in order to retrieve said information.

19. A method for retrieving information from a security document comprising the steps of
placing a security document on a capacitive touchscreen of a verification device,
moving a finger or a pen along a non-homogeneous region said security document while said region abuts against the touchscreen, thereby generating a varying capacitive signal in said touchscreen, wherein at least part of an inhomogeneity of said non-homogeneous region is formed by a window of said document,
retrieving, by means of said touchscreen, a dataset descriptive of said capacitive signal as a function of position,
analyzing said dataset in order to retrieve said information.
